(19) United States
(12) Patent Application Publication
(10) Pub. No.: US 2009/0272760 A1
(43) Pub. Date: Nov. 5, 2009

(54) Fluid Containing and Dispersing Apparatus

(76) Inventor: James Ugone, Topsfield, MA (US)

Correspondence Address: LAMBERT & ASSOCIATES, P.L.L.C., 92 STATE STREET, BOSTON, MA, 02109-2004, US

(21) Appl. No.: 12/114,874

(22) Filed: May 5, 2008

(51) Int. Cl. B67D 5/00; A47G 19/14

(52) U.S. Cl. 222/1; 222/129; 222/465.1

(57) ABSTRACT

A fluid containing and dispersing apparatus comprising, in one embodiment, a primary fluid containing chamber and a secondary fluid containing chamber, wherein said primary fluid chamber is primarily intended to contain fluids safe to touch (such as water) and said secondary chamber is primarily intended to contain other fluids (that may or may not be safe to touch). The fluid containing and dispersing apparatus features a collapsible and flexible nozzle with interchangeable fluid distribution heads, along with numerous internal and external chambers for carrying supplies, tools and equipment. Also features an easy to use pump apparatus with a fluid measuring display and a time recording feature. This design also features the secondary fluid containment chamber being used as a side handle to more efficiently use space as opposed to designs featured in the prior art.

### FIELD OF THE INVENTION

The present invention relates generally to liquid containing and liquid dispersing devices.

### REFERENCES

In general within the art, descriptions of watering devices are found in U.S. Pat. No. 7,216,780 set forth by Durant et al.; and U.S. Pat. No. 6,799,700 set forth by Durant et al.; and U.S. Pat. No. 4,392,594 set forth by Swett et al.; and U.S. Pat. No. 4,901,878 set forth by Humphries; and U.S. Pat. No. 5,722,570 set forth by Sultzer III et al.; and U.S. Pat. No. 4,030,664 set forth by Tisbo et al.

### BACKGROUND OF INVENTION

Gardeners, botanists, interior landscapers, greenhouse professionals, biology teachers, researchers and others that work with plants depend upon a variety of plant maintenance tools, equipment and supplies. Often these items must be carried by hand which commonly leads to inconvenience and inefficient use of time as most of these items are normally required to be carried separately.

Typically, prior art watering cans provided a means by which users could carry and disperse the fluids contained in the watering can. However, useful fertilizers, chemical or otherwise, would have to be premixed with said fluids before carrying away the watering can. This forces users to either carry their fertilizers with them along with their watering can and numerous other tools, or to make a trip back to the location the fertilizer to again carry out the mixing process. The prior variant is impossible when the fertilizer is held in containers too large to make physically carrying them impracticable or impossible. The former variant is wasteful, causing a great loss of time by forcing users to make back and forth trips.

A user could reasonably transfer enough of the fertilizer into a second container in order to carry both that container and the watering can and then perform mixing operations by using portions of fertilizer from the second container, thus avoiding the need to make wasteful trips back and forth for fertilizer. However, a user's hands are now occupied holding a second container, as well as other useful items will be awkward if not impossible to carry (a garden hose carried as a water source to refill the watering can for instance).

Latter prior art developed incorporating the use of separate chambers within watering cans to store liquid fertilizer. This allowed for the transporting of liquid fertilizers with the watering can, avoiding the need for a second container for the fertilizer, thus again freeing the user's hand to carry other containers and useful objects. However, these prior art inventions failed to place separate chambers in efficient and/or convenient locations.

Another limitation of prior art watering cans is that the nozzles used are commonly comprised of rigid materials that do not bend. This is undesirable in situations when trying to disperse liquid at high and hard to reach areas. Other attempts at providing flexible nozzles are little more then rubber tubes that lack the rigidity to be used practically without support to hold the nozzles in place.

Further, the prior art does not provide users with additional pouches and other tool carrying means, as part of the single watering can unit, forcing users to rely on multiple trips for tools and or to carry their tools by other means.

Also, the prior art does not provide a convenient means to mark the last time the unit was used.

Additionally, no prior art combines features in one watering can unit to overcome all these shortcomings found in the art.

What is needed is a light weight, portable, accessory-tool carrying watering can apparatus that comprises a separate fertilizer chamber that is efficiently and conveniently located with a directionally adjustable, yet ridged, nozzle. The present invention provides a solution to all these shortcomings.

### SUMMARY OF THE INVENTION

The instant invention, as illustrated herein, is clearly not anticipated, rendered obvious, or even present in any of the prior art mechanisms, either alone or in any combination thereof. A lightweight, portable, accessory-tool carrying water can apparatus with a separate fertilizer chamber and a directionally adjustable nozzle to overcome the previously mentioned shortcomings of earlier problems in the art would afford users the advantage of carrying more equipment in a single unit and more efficiently disperse fluids in positions that were previously awkward. Thus, the several embodiments of the instant invention are illustrated herein.

Therefore, it is an object of the present invention to overcome the previously mentioned shortcomings found in the prior art with an improved liquid containing and dispersing apparatus.

Another object of the present invention is to provide an improved liquid containing and dispersing apparatus that provides a flexible nozzle.

Another object of the present invention is to provide an improved liquid containing and dispersing apparatus that provides a compactable nozzle.

Another object of the present invention is to provide an improved liquid containing and dispersing apparatus that provides a self-supporting nozzle.

Another object of the present invention is to provide an improved liquid containing and dispersing apparatus that provides a secondary liquid storage chamber.

Another object of the present invention is to provide an improved liquid containing and dispersing apparatus that provides a secondary liquid storage chamber in a rear handle of said liquid containing and dispersing apparatus.

Another object of the present invention is to provide an improved liquid containing and dispersing apparatus that provides a liquid excision pump within said secondary chamber.

Another object of the present invention is to provide an improved liquid containing and dispersing apparatus that provides a measurement means, wherein said measurement means allows for the measurement of the fluids removed from said secondary chamber by said pump during a given usage session.

Another object of the present invention is to provide an improved liquid containing and dispersing apparatus that provides a plurality of apparatus-tool containing pockets about said apparatus.

Another object of the present invention is to provide an improved liquid containing and dispersing apparatus that provides a plurality of apparatus-tool containing pockets about said apparatus, wherein said pockets further comprise drainage cavities.

Another object of the present invention is to provide an improved liquid containing and dispersing apparatus that provides a chamber designed to carry work surface cushioning materials.

Another object of the present invention is to provide an improved liquid containing and dispersing apparatus that provides a comfortable to hold top gripping and carrying member.

Another object of the present invention is to provide an improved liquid containing and dispersing apparatus that provides a removable water dispersion member.

Another object of the present invention is to provide an improved liquid containing and dispersing apparatus that provides a convenient means to mark the time of last use of the apparatus to disperse liquid.

Another object of the present invention is to provide an improved liquid containing and dispersing apparatus that provides an easy-to-use pump, wherein the amount of liquid removed from a containment chamber comprising a part of the device is determined by observation of the change in the liquid level indicated on a measuring means.

Another object of the present invention is to provide an improved liquid containing and dispersing apparatus that provides an easy-to-use pump, wherein the amount of liquid removed from a single pump is not a predetermined set amount.

Another object of the present invention is to provide an improved liquid containing and dispersing apparatus that provides a substantially transparent outer surface, which allows those viewing the apparatus to view the contents inside said apparatus.

Another object of the present invention is to provide an improved liquid containing and dispersing apparatus that provides a nozzle capable of accommodating various nozzle heads.

These together with other objects of the invention, along with various features of novelty which characterize the invention, are pointed out with particularity in the claims, Detailed Description of the Embodiments Sections and drawings of this application, with all said sections adding to this disclosure.

### BRIEF DESCRIPTION OF THE DRAWINGS

FIG. 1 illustrates a side view of the improved liquid containing and dispersing apparatus and various features of this embodiment of said apparatus when viewed with said nozzle pointing to the left.

FIG. 2 illustrates a side view of the improved liquid containing and dispersing apparatus and various features of this embodiment of said apparatus when viewed with said nozzle pointing to the right.

### DETAILED DESCRIPTION OF THE DISCLOSED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as portable liquid containing and dispersing apparatuses that have various sizes, dimensions and comprised of various materials.

The present invention solves all the shortcomings found in the prior art by introducing a portable liquid containing and dispersing apparatus that comprises primary and secondary liquid containing chambers, wherein said primary chamber's function is to contain water or a mixture of water and other matter. The secondary liquid containing chamber's chief function is to contain other types of liquid matter (generally intended for containing liquid fertilizers).

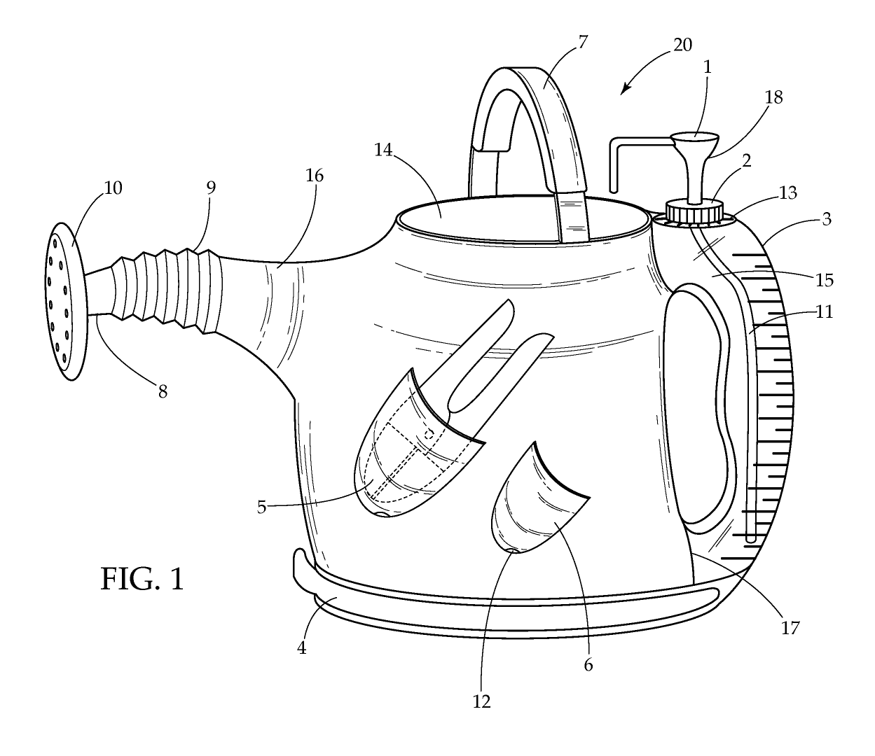

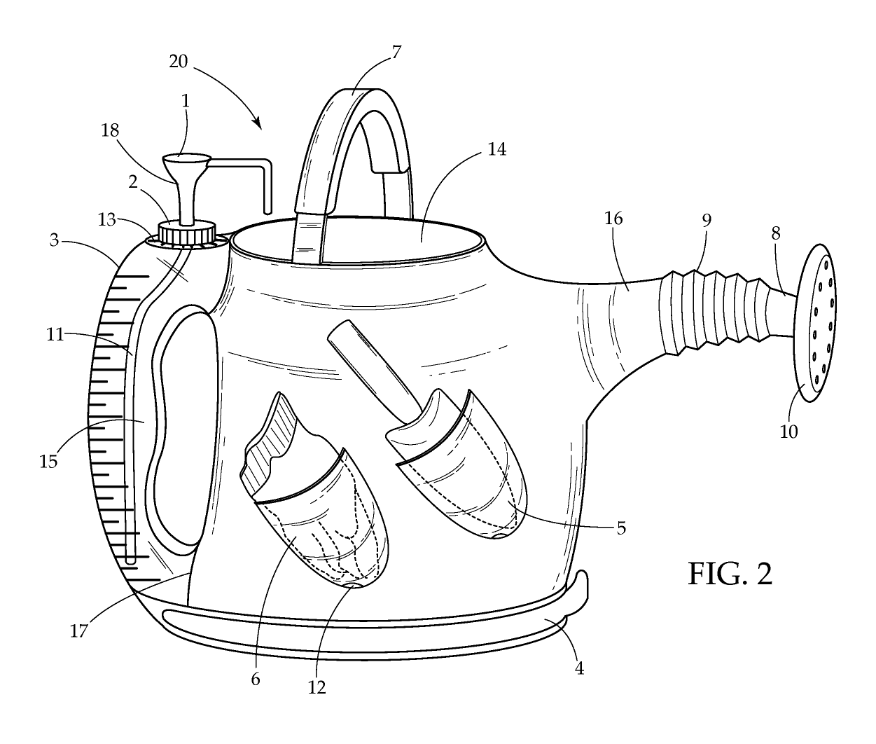

FIGS. 1 and 2 commonly illustrate opposing side views of one embodiment of the instant invention. The portable liquid containing and dispersing apparatus is illustrated as comprising a substantially transparent housing 20, a primary liquid retaining chamber 14, a secondary liquid retaining chamber 15, a gripping member 7 (preferably comprising a comfortable manual gripping material with a semi-spongeable and/or rubber like exterior) and a water dispersion assembly 16. Further, comprising the portable liquid containing and dispersing apparatus are side instrument or accessory storage chambers 5, 6 contiguously and seamlessly attached to said primary liquid retaining chamber 14 and a bottom instrument or accessory storage chamber 4 also contiguously and seamlessly attached to said primary liquid retaining chamber 14 (illustrated in FIGS. 1 and 2 as containing a working surface cushioning member). In addition, the side instrument or accessory storage chambers 5, 6 further comprise at least one cavity 12 for solid and liquid matter drainage.

The secondary storage chamber 15, is externally contiguously and seamlessly connected to said primary liquid storage chamber 14, while internally is separated by at least wall member 17. Further comprising the secondary storage chamber 15 is a manual liquid extraction assembly 18, comprising a manually depressible top member 1, a threaded sealing member 2 and fluid passage member 11. Further comprising said secondary storage chamber 15 are a liquid measurement means 3 and a usage event recording means 13 (illustrated herein as calendar dial). The manual liquid extraction assembly 18 functions in such a way that a pre-determined amount of liquid is not removed for a single depression movement of said manually depressible top member 1, allowing the user to more aptly decide on the amount of fluid removed through visual inspection of said liquid measurement means 3.

The water dispersion assembly 16 comprises a bendable and collapsible section 9, a comfortable nozzle gripping member 8 and a removable and interchangeable head member 10. Said bendable and collapsible section 9 is contiguously and seamlessly connected to said primary liquid storage chamber 14 at one end and connects to said comfortable nozzle gripping member 8 at a second end. Further, said removable and interchangeable head member 10 connects to said comfortable nozzle gripping member 8.

What is claimed is:

1. A fluid containing and dispersing apparatus comprising a plurality of fluid containment chambers, a fluid dispersing member and at least one gripping member.

2. The fluid containing and dispersing apparatus of claim 1, wherein said plurality of fluid containment chambers comprise at least one primary fluid containment chamber and at least one secondary fluid containment chamber.

3. The fluid containing and dispersing apparatus of claim 2, wherein said fluid containing and dispersing apparatus further comprises at least one external chamber substantially contiguously and substantially seamlessly attached to one member of said at least one primary fluid containment chamber.

4. The fluid containing and dispersing apparatus of claim 3, wherein said fluid containing and dispersing apparatus further comprises at least one substantially internally located chamber.

5. The fluid containing and dispersing apparatus of claim 4, wherein at least one member of said at least one secondary fluid containment chamber comprises a fluid level measuring means and a fluid extraction event marking means.

6. The fluid containing and dispersing apparatus of claim 5, wherein said apparatus further comprises a fluid extraction assembly, wherein said fluid extraction assembly comprises:
a substantially depressible head member;
a threaded securing member; and
a substantially tubular fluid passage member, wherein one end of said fluid passage member passes through a cavity in said threaded securing member and is removably attached to said head member and, wherein a second end of said fluid passage member freely rests within a member of said at least one secondary fluid retaining chamber.

7. The fluid containing and dispersing apparatus of claim 6, wherein said fluid dispersing member comprises:
a substantially conical base, wherein said conical base substantially seamlessly and substantially contiguously extends from at least one member of said at least one primary fluid containment chamber;
a substantially length reducing, substantially directionally reconfigurable and substantially conical protrusion;
a substantially tubular gripping member, wherein said tubular gripping member comprises a threaded interior and a semi-spongeable exterior; and
a fluid dispersion head member, wherein said fluid dispersion head member comprises a plurality of cavities through which fluid may pass and, wherein said head member is removably and threadedly attached to said substantially tubular gripping member.

8. The fluid containing and dispersing apparatus of claim 6, wherein said fluid dispersing member comprises:
a substantially conical base, wherein said conical base substantially seamlessly and substantially contiguously extends from at least one member of said at least one primary fluid containment chamber;
a substantially conical protrusion, wherein said substantially conical protrusion is substantially length reducing and substantially directionally reconfigurable;
a substantially tubular gripping member, wherein said tubular gripping member comprises a semi-spongeable exterior; and
a fluid dispersion head member, wherein said water dispersion head member is attached to said substantially tubular gripping member.

9. A fluid containing and dispersing apparatus comprising a plurality of fluid containment chambers, a liquid dispersing member at least one gripping member and at least one exterior containment chamber.

10. The fluid containing and dispersing apparatus of claim 9, wherein said plurality of liquid containment chambers comprise at least one liquid containment chamber and at least one fluid containment chamber, wherein at least one member of said set of at least one gripping member comprises a semi-spongeable gripping exterior.

11. The fluid containing and dispersing apparatus of claim 10, wherein said fluid containing and dispersing apparatus further comprises at least one external chamber substantially contiguously and substantially seamlessly attached to the exterior to at least one member of said at least one liquid containment member.

12. The fluid containing and dispersing apparatus of claim 11, wherein said fluid containing and dispersing apparatus further comprises at least one substantially internally located chamber, wherein said chamber is substantially seamlessly and substantially contiguously attached to the bottom end of a set of members of said at least one liquid containment member.

13. The fluid containing and dispersing apparatus of claim 12, wherein at least one member of said at least one fluid containment chamber comprises a fluid level measuring means and a fluid extraction event recording means.

14. The fluid containing and dispersing apparatus of claim 13, wherein said fluid containing and dispersing apparatus further comprises a fluid extraction assembly, wherein said fluid extraction assembly comprises:
a substantially depressible head member, wherein said head member comprises a substantially hollow interior passage through which fluids may pass;
a manual securing member, wherein said securing member comprises a threaded interior that threadedly attaches to a member of said at least one fluid containment chamber; and
a substantially tubular fluid passage member, wherein one end of said fluid passage member passes through a cavity in said threaded securing member and is removably attached to said head member and, wherein a second end of said fluid passage member freely rests within a member of said at least one secondary fluid retaining chamber.

15. The fluid containing and dispersing apparatuses of claim 14, wherein said liquid dispersing member comprises:
a substantially conical base, wherein said conical base substantially seamlessly and substantially contiguously extends from at least one member of said at least one liquid containment chamber;
a substantially length reducing and substantially directionally reconfigurable and substantially conical protrusion;
a substantially tubular gripping member, wherein said tubular gripping member comprises a threaded interior and a semi-spongeable exterior; and
a liquid dispersion head member, wherein said liquid dispersion head member comprises a plurality of cavities through which liquid may pass and, wherein said head member is removably and threadedly attached to said substantially tubular gripping member.

16. The fluid containing and dispersing apparatuses of claim 14, wherein said liquid dispersing member comprises:
a substantially conical base, wherein said conical base substantially seamlessly and substantially contiguously extends from at least one member of said at least one liquid containment chamber;
a substantially length reducing and substantially directionally reconfigurable and substantially conical protrusion;
a substantially tubular gripping member, wherein said tubular gripping member comprises a threaded interior and a semi-spongeable exterior; and
a liquid dispersion head member, wherein said liquid dispersion head member is attached to said substantially tubular gripping member.

17. A method of transporting and distributing fluids, wherein said method comprises a set of steps of placing fluids into a fluid containment apparatus, wherein said apparatus comprises a plurality of fluid containment chambers and, wherein said set of steps of placing fluids into a fluid containment apparatus comprises a set of steps to place fluids into a subset of members of said plurality of fluid containment members.

18. The method of transporting and distributing fluids of claim 17, wherein said method further comprises a set of steps to mix fluids contained in at least one fluid containment chamber with fluids contained in at least one other fluid containment chamber, wherein the mixing of said fluids produces a fluid mixture and the fluid containment chamber containing said fluid mixture is a primary fluid containment chamber.

19. The method of transporting and distributing fluids of claim 18, wherein said fluid containment apparatus further comprises a fluid distribution means and at least one gripping member and, wherein said method further comprises a set of steps to vary the angle of said fluid mixture within said primary fluid containment chamber by grasping at least one member of said at least one gripping member so that said fluid distribution means is pointing in a lower then horizontal angle to allow said fluid mixture to flow from said primary fluid containment chamber, through said fluid distribution means and out of said distribution means.

20. The method of transporting and distributing fluids of claim 19, wherein said apparatus further comprises a fluid extraction apparatus and, wherein said set of steps to mix fluids further comprises a set of steps to extract said fluids from one fluid containment chamber by performing at least one depressing motion of head member of said fluid extraction apparatus, wherein said depressing motion of said head member creates a substantial suction force extracting fluid contained in said fluid containment chamber through a fluid passage member of said fluid extraction apparatus and forcing said fluid out of said head member.
